(19) United States
(12) Patent Application Publication
(10) Pub. No.: US 2023/0234618 A1
(43) Pub. Date: Jul. 27, 2023

(54) METHOD AND APPARATUS FOR CONTROLLING AUTONOMOUS VEHICLE

(71) Applicant: HYUNDAI MOBIS CO., LTD., Seoul (KR)

(72) Inventor: Yong Kwan JI, Seoul (KR)

(73) Assignee: HYUNDAI MOBIS CO., LTD., Seoul (KR)

(21) Appl. No.: 18/074,028

(22) Filed: Dec. 2, 2022

(30) Foreign Application Priority Data
Jan. 21, 2022 (KR) 10-2022-0008973
Jan. 21, 2022 (KR) 10-2022-0008974

(51) Int. Cl. B60W 60/00; B60W 30/095

(52) U.S. Cl. CPC B60W 60/0059; B60W 30/095; B60W 60/0015; B60W 2540/221; B60W 2540/22; B60W 2540/30; B60W 2420/42; B60W 2555/20; B60W 2552/00

(57) ABSTRACT

A method for changing a control authority of an autonomous vehicle in consideration of an external environment includes determining a first risk level of a physical condition of a driver who drives the autonomous vehicle, determining a second risk level in response to one of a mental condition or a conscious condition of the driver, determining a driver proficiency level of a driver, and allocating a control authority of the autonomous vehicle to the driver or to the autonomous vehicle according to a result of a determination of the first risk level, the second risk level, and the driver proficiency level.

### CROSS-REFERENCE TO RELATED APPLICATION

This application the benefit under 35 U.S.C. § 119(a) of Korean Patent Application Nos. 10-2022-0008973 and 10-2022-0008974 both filed on Jan. 21, 2022, the disclosure of both are incorporated hereby by reference for all purposes.

### BACKGROUND

### Field of the Invention

The embodiments of the present disclosure are applicable to vehicles of all fields, and more particularly to technology for adaptively granting vehicle control authority according to the result of monitoring an external state of a vehicle while driving the vehicle at autonomous driving levels (3 to 5).

### Description of the Related Art

The Society of Automotive Engineers (SAE), the American Society of Automotive Engineers, subdivides autonomous driving levels into six levels, for example, from level 0 to level 5.

Level 0 (No Automation) refers to a level at which a driver who rides in a vehicle controls and is responsible for all of vehicle driving. At Level 0, the driver can always drive the vehicle, and a system of the vehicle is designed to perform only auxiliary functions such as emergency situation notification. In addition, vehicle driving can be controlled by the driver, variables generable during vehicle driving can be sensed by the driver, and the driver is responsible for such vehicle driving.

Level 1 (Driver Assistance) refers to a level of assisting a vehicle driver through adaptive cruise control and lane keeping functions. In Level 1, a vehicle system is activated so that driver assistance can be implemented using vehicle speed control, vehicle-to-vehicle distance maintenance, and lane keeping. Whereas vehicle driving can be controlled by all of the system and the driver, variables generable during vehicle driving can be sensed by the driver, and the driver is also responsible for such vehicle driving.

Level 2 (Partial Automation) refers to a level at which steering and acceleration/deceleration of the vehicle can be controlled by all of the driver and the vehicle for a certain period of time under specific conditions. At Level 2, it is possible to perform assistance driving in which steering of a vehicle (i.e., a host vehicle) running on a gentle curved road and the operation of maintaining a predetermined distance between a host vehicle and a preceding vehicle can be performed. However, at Level 2, variables generable during vehicle driving can be sensed by the driver, and the driver is generally responsible for such vehicle driving. At this time, the driver must always monitor the driving situation, and in a situation that the system does not automatically recognize the driving situation, the driver must immediately intervene forcibly in vehicle driving.

At Level 3 (Partial Automation), the system takes charge of driving the vehicle in a section under certain conditions such as a highway, and the driver intervenes in driving the vehicle only in hazardous situations. At Level 3, variables generable during the vehicle driving can be sensed by the system, so that there is no need to perform the above monitoring in a different way from Level 2. However, if the driving situation exceeds the system requirements, the system requests the driver to immediately intervene in driving the vehicle.

Level 4 (High Automation) enables autonomous driving of the vehicle on most roads. In Level 4, vehicle driving can be controlled by the system, and the system is responsible for such vehicle driving. The driver need not intervene in driving the vehicle on most roads except for roads under restricted situations. However, at Level 4, in certain conditions such as bad weather, the system may request the driver to immediately intervene in driving the vehicle, so that a vehicle driving control device capable of being controlled by humans such as the driver is needed in Level 4.

Level 5 (Full Automation) refers to a level at which the driver need not intervene in driving the vehicle, and the vehicle can be autonomously driven only by an occupant (or a passenger), not the driver. At Level 5, if the occupant inputs a destination to the system, the system takes charge of autonomous driving under all conditions. At Level 5, control devices for vehicle steering and acceleration/deceleration of the vehicle are unnecessary for autonomous driving.

Meanwhile, Korea has established Level 3 autonomous vehicle safety standards in 2020 in consideration of the international standards being discussed in the World Forum for Harmonization of Vehicle Regulations (UN/ECE/WP.29) under the United Nations that have prepared the international standard limiting the speed of Level 3 autonomous driving.

However, research on technology for granting the vehicle control authority to a driver according to specific conditions or for retrieving the vehicle control authority granted to the driver from the driver while the vehicle is driving at the aforementioned autonomous driving levels of 3 to 5 has not yet been developed sufficiently. That is, according to the related art, there is a problem in that the vehicle control authority is not adaptively shifted according to road conditions, weather conditions, the driving proficiency levels of the driver, and the like.

Furthermore, the related art has disadvantages in that individual difference and characteristics of the driver located inside the autonomous vehicle cannot be reflected in autonomous driving.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features and aspects will be apparent from the following detailed description, the drawings, and the claims.

In one general aspect, here is provide a method for changing a control authority of an autonomous vehicle including determining first a risk level of a physical condition of a driver who drives an autonomous vehicle, determining a second risk level in response to one of a mental condition or a conscious condition of the driver, determining a driving proficiency level of the driver, and allocating a control authority of the autonomous vehicle to the driver or to the autonomous vehicle according to a result of a determination of the first risk level, the second risk level, and the driving proficiency level.

The determining the second risk level may include sensing the conscious condition of the driver using a camera installed in the autonomous vehicle.

The determining the second risk level may include analyzing the mental condition of the driver by having a conversation with the driver through an artificial intelligence (AI) speaker installed in the autonomous vehicle.

The method may include using any one of autonomous driving levels 3 to 5.

In another general aspect, here is provided machine-readable storage medium, including executable instructions, that, when executed by a processing system including a processor, facilitate performance of operations that include determining a first risk level of a physical condition of a driver who driving an autonomous vehicle associated with the processor, determining a second risk level in response to one of a mental condition or a conscious condition of the driver, determining a third risk level in response to a driving proficiency level of the driver, and allocating a control authority of the autonomous vehicle to the driver or to the autonomous vehicle according to a result of a determination of the first risk level, the second risk level, and the third risk level.

In another general aspect, here is provided an autonomous vehicle, the autonomous vehicle including a first sensor configured to determine a first risk level of a physical condition of a driver who drives the autonomous vehicle, a second sensor configured to determine a second risk level in response to one of a mental condition or a conscious condition of the driver, and a controller that is configured to determine a driving proficiency level of the driver by referring to a database stored in a memory and allocate a control authority of the autonomous vehicle to the driver or to the autonomous vehicle according to a result of a determination of the first risk level, the second risk level, and the driving proficiency level.

The first sensor may include a biometric sensor and the second sensor may include one of a camera or includes an artificial intelligence (AI) camera.

The autonomous vehicle may be used in any one of autonomous driving levels 3 to 5.

In another general aspect, here is provided a method for changing a control authority of an autonomous vehicle that include determining a first risk level in response to a weather condition, determining a second risk level in response to a road condition, determining a driver proficiency level of a driver of an autonomous vehicle, and allocating a control authority of the autonomous vehicle to one of the driver or to the autonomous vehicle according to a result of a determination of the first risk level, the second risk level, and the driver proficiency level.

The determining the driver proficiency level may include determining the driver proficiency level using at least one of an accident occurrence risk, an acceleration/deceleration pattern, and a lane change pattern.

The accident occurrence risk may be determined using at least one of a risk of collision with a preceding vehicle, a risk of collision with a side-lane vehicle, and a risk of collision with a following vehicle.

The autonomous vehicle may be used in any one of autonomous driving levels 3 to 5.

In another general aspect here is provided an autonomous vehicle, the autonomous vehicle including a communication unit configured to receive weather condition information from a server, a camera configured to capture a road image showing a road condition, and a controller, wherein the controller is configured to determine a first risk level in response to a weather condition, determine a second risk level in response to a road condition, determine a driver proficiency level of a driver by referring to a database stored in a memory, and allocate a control authority of the autonomous vehicle to the driver or to the autonomous vehicle according to a result of determination of the first risk level, the second risk level, and the driver proficiency level.

The controller may be configured to determine the driver proficiency level using at least one of an accident occurrence risk, an acceleration/deceleration pattern, and a lane change pattern.

The controller may be configured to determine the accident occurrence risk using at least one of a risk of collision with a preceding vehicle, a risk of collision with a side-lane vehicle, and a risk of collision with a following vehicle.

The autonomous vehicle nay be used in any one of autonomous driving levels 3 to 5.

### BRIEF DESCRIPTION OF THE DRAWINGS

FIG. 1 is an overall block diagram of an autonomous driving control system to which an autonomous driving apparatus according to any one of embodiments of the present disclosure is applicable.

FIG. 2 is a diagram illustrating an example in which an autonomous driving apparatus according to any one of embodiments of the present disclosure is applied to a vehicle.

FIG. 3 is a block diagram illustrating constituent elements of an autonomous vehicle according to any one of the embodiments of the present disclosure.

FIG. 4 is a flowchart illustrating a method for controlling the autonomous vehicle according to any one of the embodiments of the present disclosure.

FIG. 5 is a software block diagram illustrating an artificial intelligence (AI) robot embedded in the autonomous vehicle according to an embodiment of the present disclosure.

FIG. 6 is a hardware block diagram illustrating an artificial intelligence (AI) robot embedded in the autonomous vehicle according to an embodiment of the present disclosure.

FIG. 7 is a flowchart illustrating a method of distributing vehicle control authority in consideration of the driver's conditions.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element. \

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

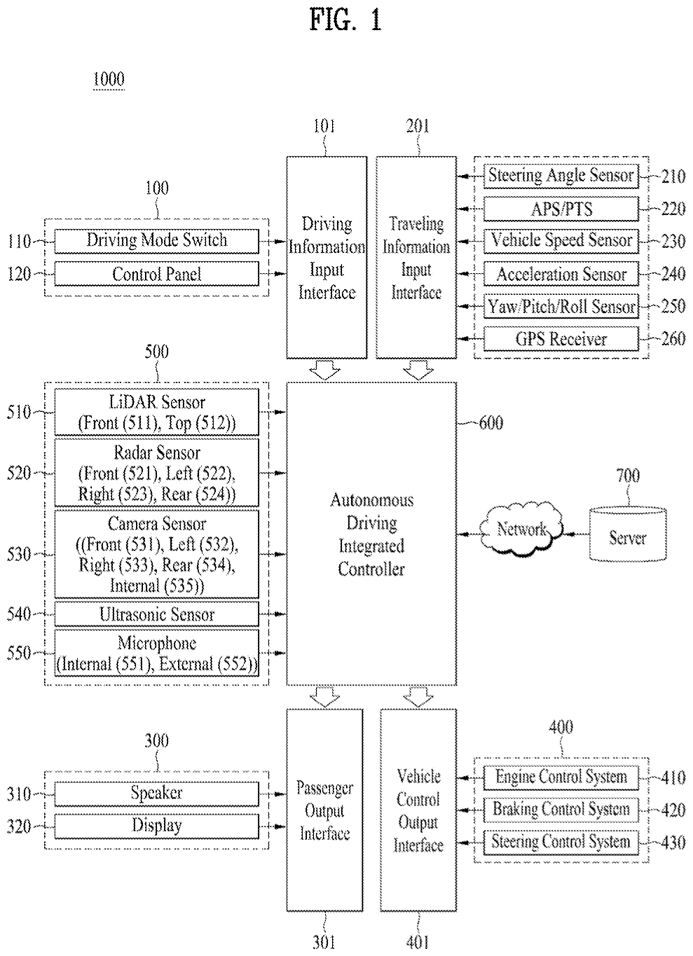

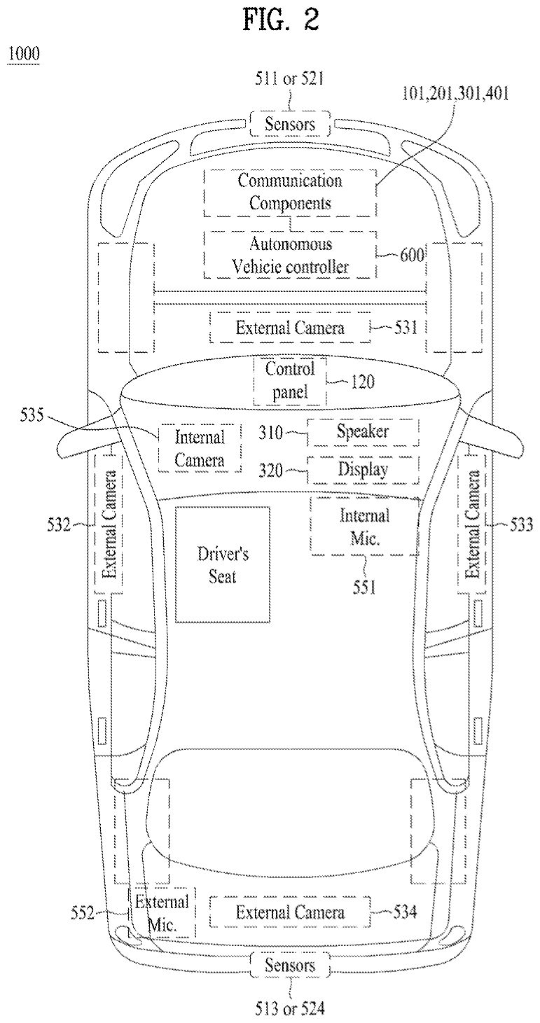

FIG. 1 is an overall block diagram of an autonomous driving control system to which an autonomous driving apparatus according to any one of embodiments of the present disclosure is applicable. FIG. 2 is a diagram illustrating an example in which an autonomous driving apparatus according to any one of embodiments of the present disclosure is applied to a vehicle.

First, a structure and function of an autonomous driving control system (e.g., an autonomous driving vehicle) to which an autonomous driving apparatus according to the present embodiments is applicable will be described with reference to FIGS. 1 and 2.

As illustrated in FIG. 1, an autonomous driving vehicle 1000 may be implemented based on an autonomous driving integrated controller 600 that transmits and receives data necessary for autonomous driving control of a vehicle through a driving information input interface 101, a traveling information input interface 201, an occupant output interface 301, and a vehicle control output interface 401. However, the autonomous driving integrated controller 600 may also be referred to herein as a controller, a processor, or, simply, a controller.

The autonomous driving integrated controller 600 may obtain, through the driving information input interface 101, driving information based on manipulation of an occupant for a user input unit 100 in an autonomous driving mode or manual driving mode of a vehicle. As illustrated in FIG. 1, the user input unit 100 may include a driving mode switch 110 and a control panel 120 (e.g., a navigation terminal mounted on the vehicle or a smartphone or tablet computer owned by the occupant). Accordingly, driving information may include driving mode information and navigation information of a vehicle.

For example, a driving mode (i.e., an autonomous driving mode/manual driving mode or a sports mode/eco mode/safety mode/normal mode) of the vehicle determined by manipulation of the occupant for the driving mode switch 110 may be transmitted to the autonomous driving integrated controller 600 through the driving information input interface 101 as the driving information.

Furthermore, navigation information, such as the destination of the occupant input through the control panel 120 and a path up to the destination (e.g., the shortest path or preference path, selected by the occupant, among candidate paths up to the destination), may be transmitted to the autonomous driving integrated controller 600 through the driving information input interface 101 as the driving information.

The control panel 120 may be implemented as a touchscreen panel that provides a user interface (UI) through which the occupant inputs or modifies information for autonomous driving control of the vehicle. In this case, the driving mode switch 110 may be implemented as touch buttons on the control panel 120.

In addition, the autonomous driving integrated controller 600 may obtain traveling information indicative of a driving state of the vehicle through the traveling information input interface 201. The traveling information may include a steering angle formed when the occupant manipulates a steering wheel, an accelerator pedal stroke or brake pedal stroke formed when the occupant depresses an accelerator pedal or brake pedal, and various types of information indicative of driving states and behaviors of the vehicle, such as a vehicle speed, acceleration, a yaw, a pitch, and a roll formed in the vehicle. The traveling information may be detected by a traveling information detection unit 200, including a steering angle sensor 210, an accelerator position sensor (APS)/pedal travel sensor (PTS) 220, a vehicle speed sensor 230, an acceleration sensor 240, and a yaw/pitch/roll sensor 250, as illustrated in FIG. 1.

Furthermore, the traveling information of the vehicle may include location information of the vehicle. The location information of the vehicle may be obtained through a global positioning system (GPS) receiver 260 applied to the vehicle. Such traveling information may be transmitted to the autonomous driving integrated controller 600 through the traveling information input interface 201 and may be used to control the driving of the vehicle in the autonomous driving mode or manual driving mode of the vehicle.

The autonomous driving integrated controller 600 may transmit driving state information provided to the occupant to an output unit 300 through the occupant output interface 301 in the autonomous driving mode or manual driving mode of the vehicle. That is, the autonomous driving integrated controller 600 transmits the driving state information of the vehicle to the output unit 300 so that the occupant may check the autonomous driving state or manual driving state of the vehicle based on the driving state information output through the output unit 300. The driving state information may include various types of information indicative of driving states of the vehicle, such as a current driving mode, transmission range, and speed of the vehicle.

If it is determined that it is necessary to warn a driver in the autonomous driving mode or manual driving mode of the vehicle along with the above driving state information, the autonomous driving integrated controller 600 transmits warning information to the output unit 300 through the occupant output interface 301 so that the output unit 300 may output a warning to the driver. In order to output such driving state information and warning information acoustically and visually, the output unit 300 may include a speaker 310 and a display 320 as illustrated in FIG. 1. In this case, the display 320 may be implemented as the same device as the control panel 120 or may be implemented as an independent device separated from the control panel 120.

Furthermore, the autonomous driving integrated controller 600 may transmit control information for driving control of the vehicle to a lower control system 400, applied to the vehicle, through the vehicle control output interface 401 in the autonomous driving mode or manual driving mode of the vehicle. As illustrated in FIG. 1, the lower control system 400 for driving control of the vehicle may include an engine control system 410, a braking control system 420, and a steering control system 430. The autonomous driving integrated controller 600 may transmit engine control information, braking control information, and steering control information, as the control information, to the respective lower control systems 410, 420, and 430 through the vehicle control output interface 401. Accordingly, the engine control system 410 may control the speed and acceleration of the vehicle by increasing or decreasing fuel supplied to an engine. The braking control system 420 may control the braking of the vehicle by controlling braking power of the vehicle. The steering control system 430 may control the steering of the vehicle through a steering device (e.g., motor driven power steering (MDPS) system) applied to the vehicle.

As described above, the autonomous driving integrated controller 600 according to the present embodiment may obtain the driving information based on manipulation of the driver and the traveling information indicative of the driving state of the vehicle through the driving information input interface 101 and the traveling information input interface 201, respectively, and transmit the driving state information and the warning information, generated based on an autonomous driving algorithm, to the output unit 300 through the occupant output interface 301. In addition, the autonomous driving integrated controller 600 may transmit the control information generated based on the autonomous driving algorithm to the lower control system 400 through the vehicle control output interface 401 so that driving control of the vehicle is performed.

In order to guarantee stable autonomous driving of the vehicle, it is necessary to continuously monitor the driving state of the vehicle by accurately measuring a driving environment of the vehicle and to control driving based on the measured driving environment. To this end, as illustrated in FIG. 1, the autonomous driving apparatus according to the present embodiment may include a sensor unit 500 for detecting a nearby object of the vehicle, such as a nearby vehicle, pedestrian, road, or fixed facility (e.g., a signal light, a signpost, a traffic sign, or a construction fence).

The sensor unit 500 may include one or more of a LiDAR sensor 510, a radar sensor 520, or a camera sensor 530, in order to detect a nearby object outside the vehicle, as illustrated in FIG. 1.

The LiDAR sensor 510 may transmit a laser signal to the periphery of the vehicle and detect a nearby object outside the vehicle by receiving a signal reflected and returning from a corresponding object. The LiDAR sensor 510 may detect a nearby object located within the ranges of a preset distance, a preset vertical field of view, and a preset horizontal field of view, which are predefined depending on specifications thereof. The LiDAR sensor 510 may include a front LiDAR sensor 511, a top LiDAR sensor 512, and a rear LiDAR sensor 513 installed at the front, top, and rear of the vehicle, respectively, but the installation location of each LiDAR sensor and the number of LiDAR sensors installed are not limited to a specific embodiment. A threshold for determining the validity of a laser signal reflected and returning from a corresponding object may be previously stored in a memory (not illustrated) of the autonomous driving integrated controller 600. The autonomous driving integrated controller 600 may determine a location (including a distance to a corresponding object), speed, and moving direction of the corresponding object using a method of measuring time taken for a laser signal, transmitted through the LiDAR sensor 510, to be reflected and returning from the corresponding object.

The radar sensor 520 may radiate electromagnetic waves around the vehicle and detect a nearby object outside the vehicle by receiving a signal reflected and returning from a corresponding object. The radar sensor 520 may detect a nearby object within the ranges of a preset distance, a preset vertical field of view, and a preset horizontal field of view, which are predefined depending on specifications thereof. The radar sensor 520 may include a front radar sensor 521, a left radar sensor 522, a right radar sensor 523, and a rear radar sensor 524 installed at the front, left, right, and rear of the vehicle, respectively, but the installation location of each radar sensor and the number of radar sensors installed are not limited to a specific embodiment. The autonomous driving integrated controller 600 may determine a location (including a distance to a corresponding object), speed, and moving direction of the corresponding object using a method of analyzing power of electromagnetic waves transmitted and received through the radar sensor 520.

The camera sensor 530 may detect a nearby object outside the vehicle by photographing the periphery of the vehicle and detect a nearby object within the ranges of a preset distance, a preset vertical field of view, and a preset horizontal field of view, which are predefined depending on specifications thereof.

The camera sensor 530 may include a front camera sensor 531, a left camera sensor 532, a right camera sensor 533, and a rear camera sensor 534 installed at the front, left, right, and rear of the vehicle, respectively, but the installation location of each camera sensor and the number of camera sensors installed are not limited to a specific embodiment. The autonomous driving integrated controller 600 may determine a location (including a distance to a corresponding object), speed, and moving direction of the corresponding object by applying predefined image processing to an image captured by the camera sensor 530.

In addition, an internal camera sensor 535 for capturing the inside of the vehicle may be mounted at a predetermined location (e.g., rear view mirror) within the vehicle. The autonomous driving integrated controller 600 may monitor a behavior and state of the occupant based on an image captured by the internal camera sensor 535 and output guidance or a warning to the occupant through the output unit 300.

As illustrated in FIG. 1, the sensor unit 500 may further include an ultrasonic sensor 540 in addition to the LiDAR sensor 510, the radar sensor 520, and the camera sensor 530 and further adopt various types of sensors for detecting a nearby object of the vehicle along with the sensors.

FIG. 2 illustrates an example in which, in order to aid in understanding the present embodiment, the front LiDAR sensor 511 or the front radar sensor 521 is installed at the front of the vehicle, the rear LiDAR sensor 513 or the rear radar sensor 524 is installed at the rear of the vehicle, and the front camera sensor 531, the left camera sensor 532, the right camera sensor 533, and the rear camera sensor 534 are installed at the front, left, right, and rear of the vehicle, respectively. However, as described above, the installation location of each sensor and the number of sensors installed are not limited to a specific embodiment.

Furthermore, in order to determine a state of the occupant within the vehicle, the sensor unit 500 may further include a bio sensor for detecting bio signals (e.g., heart rate, electrocardiogram, respiration, blood pressure, body temperature, electroencephalogram, photoplethysmography (or pulse wave), and blood sugar) of the occupant. The bio sensor may include a heart rate sensor, an electrocardiogram sensor, a respiration sensor, a blood pressure sensor, a body temperature sensor, an electroencephalogram sensor, a photoplethysmography sensor, and a blood sugar sensor.

Finally, the sensor unit 500 additionally includes a microphone 550 having an internal microphone 551 and an external microphone 552 used for different purposes.

The internal microphone 551 may be used, for example, to analyze the voice of the occupant in the autonomous driving vehicle 1000 based on AI or to immediately respond to a direct voice command of the occupant.

In contrast, the external microphone 552 may be used, for example, to appropriately respond to safe driving by analyzing various sounds generated from the outside of the autonomous driving vehicle 1000 using various analysis tools such as deep learning.

For reference, the symbols illustrated in FIG. 2 may perform the same or similar functions as those illustrated in FIG. 1. FIG. 2 illustrates in more detail a relative positional relationship of each component (based on the interior of the autonomous driving vehicle 1000) as compared with FIG. 1.

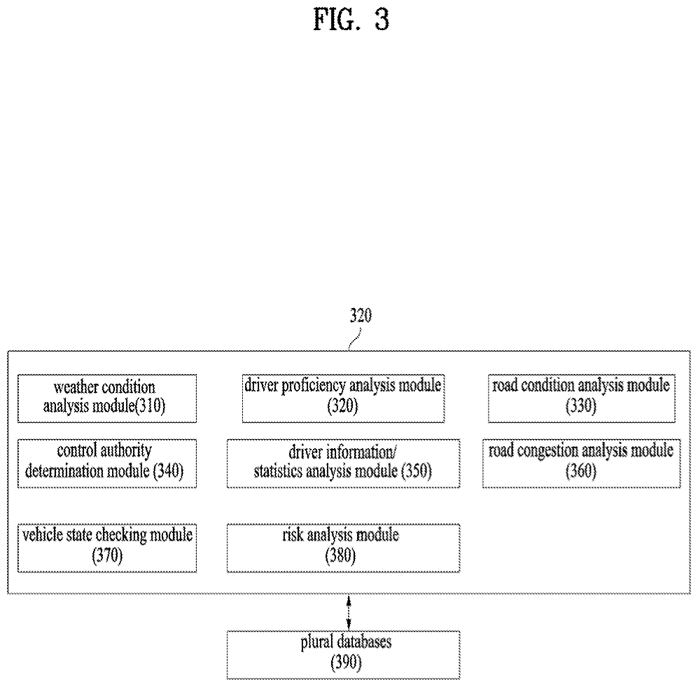

FIG. 3 is a block diagram illustrating constituent elements of an autonomous vehicle according to any one of the embodiments of the present disclosure.

Referring to FIG. 3, a controller 320 included in the autonomous vehicle according to one embodiment of the present disclosure may include a weather condition analysis module 310, a driver proficiency analysis module 320, a road condition analysis module 330, a control authority determination module 340, a driver information/statistics analysis module 350, a road congestion analysis module 360, a vehicle state checking module 370, a risk analysis module 380, and the like. In addition, referring to the plurality of databases 390, it is determined whether the control authority of the autonomous vehicle is maintained in the vehicle or assigned to the driver.

For example, the weather condition analysis module 310 may be designed to determine the degree of risk according to a weather condition based on information such as rain, snow (snow/high snow, etc.), fog, strong wind, temperature change, natural disasters, and the like.

The road condition analysis module 330 may be designed to determine the degree of risk according to a road condition based on road information, for example, a road congestion level (e.g., road congestion levels for each time zone, road types (highway/downtown street/local road), the presence/absence of an accident, etc.), road conditions (e.g., a frozen road, road surface states (e.g., asphalt road/cement road/potholes)), road widths (highway/downtown street/local road), and road facilities (e.g., tollgates, rest stops, gas stations, drowsiness shelters, etc.).

The vehicle state checking module 370 may check whether the vehicle is faulty, may recognize states (e.g., battery states, oil states, brake states, etc.) for each function of the vehicle, and may determine whether autonomous driving is possible according to vehicle states.

The driver proficiency analysis module 320 may analyze the driver's driving proficiency based on information such as driver information and traffic accident statistical values (for example, age, gender, occupation, driving career, etc.).

Furthermore, the driver proficiency analysis module 320 may analyze the risk of traffic accident occurring while the driver is driving the vehicle, and may analyze the risk of traffic accident using sensor information such as front/side/rear cameras, a radar sensor, and a Lidar sensor mounted on the vehicle. In this case, it is possible to quantify the risk of collision by calculating TTC (Time to Collision) values.

In addition, the driver proficiency analysis module 320 may establish a determination criterion for each risk by learning the above-described information. For example, the risk of collision with the preceding vehicle is classified into three levels (high/medium/low), the risk of collision with a side vehicle running in a neighboring lane is classified into three levels (high/medium/low), and the risk of collision with a rear vehicle (i.e., the following vehicle) is classified into three levels (high/medium/low).

The driver proficiency analysis module 320 may determine the risk of accident occurrence frequency according to the level of the risk of collision with the preceding vehicle, the level of side-lane collision risk, and the level of rear collision risk. More specifically, for example, when forward collision risk (high), side-lane collision risk (high), and rear collision risk (high) are established, the risk of accident occurrence frequency may be determined to be the highest level (i.e., ‘high’).

On the other hand, when forward collision risk (medium), side-lane collision risk (medium), and rear collision risk (medium) are established, the risk of accident occurrence frequency may be determined to be ‘medium’, which is an intermediate level. When forward collision risk (low), side-lane collision risk (low), and rear collision risk (low) are established, the risk of accident occurrence frequency may be determined to be ‘low’, which is the lowest level.

Finally, the driver proficiency analysis module 320 may finally determine the driving proficiency of the driver based on the aforementioned accident occurrence frequency risk levels, acceleration/deceleration pattern related levels, and lane change pattern related levels. For example, if the level of the accident occurrence frequency is set to ‘low’, the level of the acceleration/deceleration pattern is set to ‘high’ or ‘medium’, and the level of the lane change pattern is ‘proficient’ or ‘normal’, the overall driving proficiency level may be determined to be the highest (best) level. On the other hand, when the level of accident occurrence frequency is set to ‘medium’ or ‘low’, the level of the acceleration/deceleration pattern is set to ‘high’ or ‘medium’, and the level of the lane change pattern is set to ‘proficient’ or ‘normal’, the overall driving proficiency level may be set to ‘medium’ corresponding to the intermediate level. In addition, when the level of the accident occurrence frequency is set to ‘high’, the acceleration/deceleration pattern level is set to ‘medium’ or ‘low’, and the lane change pattern level is set to ‘immature’ or ‘normal’, the overall driving proficiency level may be determined to be the lowest level ‘low’.

The weather condition analysis module 310 may analyze weather conditions interfering with vehicle driving, for example, rain (rainfall), snow (snowfall), fog, etc., and may analyze road frozen state information according to temperature (the degrees above/below zero). Based on the analyzed result, the degree of risk according to weather conditions may be determined to be ‘high’ corresponding to, for example, heavy snow, heavy rain, typhoon, fog, strong wind, natural disaster, or temperature below zero (when a frozen road caused by snow/rain before vehicle driving is expected), or the degree of risk according to weather conditions may be determined to be ‘low’ corresponding to, for example, clear, cloudy, temperature above zero (when a frozen road is not expected).

The road state analysis module 330 may analyze the road congestion information (A) based on the following information.

(A-1): for each time zone: the morning/evening rush hour information, holiday information, etc.

(A-2): Real-time traffic information

(A-3): The number of surrounding vehicles and the speed of other vehicles, which are detected by vehicle sensors (radar, camera, Lidar, etc.) mounted on the vehicle.

(A-4): The speed of vehicles and the congestion of vehicles according to road types (highway/downtown street/local road, etc.)

(A-5): Whether or not there is an accident on the road

Further, the road condition analysis module 330 may analyze road condition information (B) based on the following information.

(B-1): Road surface conditions, such as frozen road, hydroplaning, etc., caused by rainfall/snowfall/temperature, etc.

(B-2): Condition caused by road corrosion, sinkholes, potholes, etc.

(B-3): Presence/absence of road construction

The road condition analysis module 330 may analyze the road facility information (C) based on the following information.

(C-1): Complexity of entering and exiting drowsiness shelters/rest stops/gas stations

Finally, based on the analysis results of A, B, and C information, the road condition analysis module 330 may determine the risk of road condition to be ‘high’ when the vehicle congestion on the road is high or the traffic flow is not smooth. In the remaining cases other than the above case indicating “vehicle congestion=high” or “traffic flow=not smooth”, the road condition analysis module 330 may determine the risk of road condition to be ‘low’.

According to the above-described level determination result, the control authority determination module 340 may determine a change time and range of the vehicle control authority.

That is, the control authority determination module 340 may determine the vehicle control authority switching time as follows in consideration of the weather condition, the road condition, the driver's driving proficiency, and the like.

TABLE 1

| Control Authority | |
|---|---|
| Ownership Entity | Conditions |
| Vehicle | Driver's Driving Proficiency = “LOW” or |
| | Weather Risk = “HIGH” and Road Risk = |
| | “HIGH” |
| | Driver's Driving Proficiency = “MEDIUM” |
| | Weather Risk = “HIGH” and Road Risk = |
| | “HIGH” |
| Driver | Driver's Driving Proficiency = “HIGH” |
| | Weather Risk = “HIGH/LOW” and Road Risk = |
| | “HIGH/LOW” |
| | Driver's Driving Proficiency = “MEDIUM” |
| | Weather Risk = “LOW” and Road Risk = |
| | “LOW” |

Furthermore, the control authority determination module 340 may establish the vehicle control authority ranges differently in detail as follows in consideration of weather conditions, road conditions, the driver's driving proficiency levels, and the like.

When the driving proficiency level corresponds to ‘LOW’, the entire function may be designed to be allocated to the autonomous vehicle.

On the other hand, when the side-lane collision risk level corresponds to ‘HIGH’ or the driver's risk level corresponds to ‘HIGH’, the lane change control function may be provided to the autonomous vehicle. In addition, when the level of forward collision risk corresponds to ‘HIGH’ or when the rear collision risk level corresponds to ‘HIGH’, the acceleration/deceleration control function may be provided to the autonomous vehicle. Otherwise, the control authority for each function may be transferred to the driver.

In summary, the autonomous vehicle designed to change the control authority in consideration of external environments, etc. may include a communication unit (not shown) configured to receive weather condition information from a server, and a camera (e.g., the sensor unit 500 shown in FIG. 1) configured to capture a road image showing a road state, a controller (e.g., the autonomous driving integrated controller 600), and the like.

In particular, the controller may determine the risk level according to the weather condition, may determine the risk level according to the road condition, may determine the driver's driving proficiency level by referring to the databases stored in the memory, and may allocate the control authority of the autonomous vehicle to the driver or the autonomous vehicle according to the determination result of the above three levels.

Furthermore, the controller may determine the driver's driving proficiency level using at least one of the accident occurrence risk, the acceleration/deceleration pattern, or the lane change pattern.

In addition, the controller may determine the risk of accident occurrence using at least one of the risk of collision with a preceding vehicle, the risk of collision with a side-lane vehicle, or the risk of rear collision.

Meanwhile, as shown in FIG. 3, the embodiments of the present disclosure may be designed to refer to various levels using the plurality of databases 390. According to one embodiment of the present disclosure, the respective databases can be more specifically defined as follows.

The first database related to the risk of collision with the preceding vehicle is as follows.

TABLE 2

| Risk of Collision | |
|---|---|
| with Preceding Vehicle | Determination Criteria |
| Level 1 | More than 50 times/day within 0.5 m |
| Level 2 | More than 20 times/day within 0.5 m and less |
| | than 50 times/day within 0.5 m |
| Level 3 | Less than 20 times/day within 0.5 m |

The second database related to the risk of collision with a side-lane vehicle is as follows.

TABLE 3

| Risk of Collision | |
|---|---|
| with Side-lane Vehicle | Determination Criteria |
| Level 1 | More than 30 times/day within 0.3 m |
| Level 2 | More than 10 times/day within 0.3 m and |
| | Less than 30 times/day within 0.3 m |
| Level 3 | Less than 10 times/day within 0.3 m |

The third database related to the risk of rear collision is as follows.

TABLE 4

| Risk of Rear Collision | Determination Criteria |
|---|---|
| Level 1 | More than 50 times/day within 0.5 m |
| Level 2 | More than 20 times/day within 0.5 m and |
| | Less than 50 times/day within 0.5 m |
| Level 3 | Less than 20 times/day within 0.5 m |

In addition, referring to the above-described first to third databases, the risk of accident occurrence is comprehensively determined.

That is, when at least two of levels stored in the first to third databases correspond to ‘Level 1’, the risk of accident occurrence may be designed to be regarded as ‘Level 1’ (the most dangerous situation).

On the other hand, when at least two of levels stored in the first to third databases correspond to ‘Level 3’ and the remaining one level other than the two levels does not correspond to ‘Level 1’, the overall level of the risk of accident occurrence may be determined to be ‘Level 2’ (corresponding to the risk of intermediate level).

On the other hand, when the risk of accident occurrence does not correspond to the above-described ‘Level 1’ or ‘Level 3’, this situation is regarded as ‘Level 2’ (corresponding to a situation that is rarely dangerous).

The fourth database related to the acceleration/deceleration pattern is as follows.

TABLE 5

| Acceleration/ | |
|---|---|
| deceleration pattern | Determination criteria |
| Level 1 | The number of ascents of 10 km/h or more |
| | within 1 second is more than 10 times/day |
| Level 2 | The number of ascents of 10 km/h or more |
| | within 1 second is at least 3 times/day and |
| | less than 10 times/day |
| Level 3 | The number of ascents of 10 km/h or more |
| | within 1 second is less than 3 times/day |

The fifth database related to a lane change pattern is as follows.

TABLE 6

| Lane Change Pattern | Determination criteria |
|---|---|
| Level 1 | The number of lane changes is less than |
| | 3 times/day after more than 1 minute has |
| | passed since turn signal activated |
| Level 2 | The number of lane changes is more than |
| | 3 times/day and less than 10 times/day |
| | after more than 1 minute has passed since |
| | turn signal activated |
| Level 3 | The number of lane changes is more than |
| | 10 times/day after more than 1 minute has |
| | passed since turn signal activated |

The sixth database related to comprehensive decision of the driver's driving proficiency is as follows.

TABLE 7

| Comprehensive Decision of | |
|---|---|
| Driver's Driving Proficiency | Determination criteria |
| Level 1 | The risk of accident occurrence: Level 3 |
| | Acceleration/deceleration pattern: Level |
| | 1 or Level 2 |
| | Lane change pattern: Level 1 or Level 2 |
| Level 2 | The risk of accident occurrence: Level 2 |
| | or Level 3 |
| | Acceleration/deceleration pattern: Level |
| | 1 or Level 2 |
| | Lane change pattern: Level 1 or Level 2 |
| Level 3 | The risk of accident occurrence: Level 1 |
| | Acceleration/deceleration pattern: Level |
| | 2 or Level 3 |
| | Lane change pattern: Level 2 or Level 3 |

The seventh database related to risk decision according to weather conditions is as follows.

TABLE 8

| Risk according to | |
|---|---|
| weather conditions | Determination criteria |
| Level 1 | Case corresponding to at least one of heavy |
| | snow/heavy rain/typhoon/fog/strong |
| | wind/temperature below zero |
| Level 2 | Corresponding to the remaining cases (sunny |
| | weather, cloudy weather, etc.) |

The eighth database related to risk decision according to road conditions is as follows.

TABLE 9

| Risk according to | |
|---|---|
| road conditions | Determination criteria |
| Level 1 | When traffic congestion of the traveling |
| | road is high or traffic flow is not smooth |
| Level 2 | Corresponding to the remaining cases |

The ninth database related to control authority switching time determination is as follows.

TABLE 10

| Control Authority | |
|---|---|
| Subject | Reference Database and Level |
| Autonomous Vehicle | Level 3 of Sixth DB |
| | Level 2 of Sixth DB & |
| | Level 1 of Seventh DB & |
| | Level 1 of Eighth DB |
| Driver | Level 1 of Sixth DB & |
| | Level 1 or Level 2 of Seventh DB & |
| | Level 1 or Level 2 of Eighth DB |
| | Level 2 of Sixth DB & |
| | Level 2 of Seventh DB & |
| | Level 2 of Eighth DB |

According to another embodiment of the present disclosure, when the driver wants to transfer the control authority for each function of the vehicle or when the driver's reaction (for example, when there is no manipulation such as steering, acceleration/deceleration, etc.) does not occur for a predetermined time period, the control authority is designed to be immediately granted to the autonomous vehicle, resulting in an increase in driving safety.

According to still another embodiment of the present disclosure, even after the vehicle control authority for the driver is changed based on the aforementioned ninth database, the vehicle may continuously monitor the driver's driving pattern or the driver's health state, etc. If the driving pattern of the driver is problematic or if the abnormal signal is detected in the health state, the vehicle is designed to automatically retrieve the control authority from the driver.

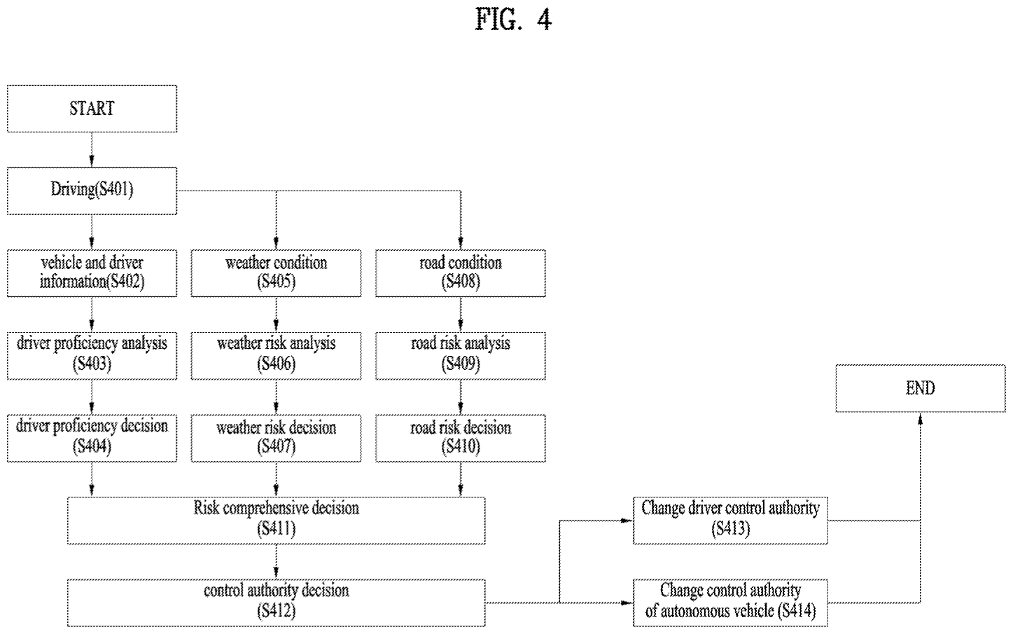

FIG. 4 is a flowchart illustrating a method for controlling the autonomous vehicle according to any one of the embodiments of the present disclosure.

Referring to FIG. 4, the autonomous vehicle according to one embodiment of the present disclosure may start driving (S401). As soon as the autonomous vehicle starts driving, the autonomous vehicle may collect information about the vehicle and the driver (S402). The autonomous vehicle may analyze the driver's driving proficiency (S403) and may determine the driver's driving proficiency based on the analyzed result (S404).

Specifically, the embodiments of the present disclosure may be designed to refer to the above-described sixth database (DB) from among various databases (DBs) stored in the memory.

Furthermore, the autonomous vehicle may collect weather condition information (S405), may analyze the weather risk (S406), and may determine the weather risk based on the analyzed result (S407). In this case, the autonomous vehicle may be designed to refer to the above-described seventh database (DB) among various DBs stored in the memory.

In addition, the autonomous vehicle may collect road condition information (S408), may analyze the road risk (S409), and may determine the road risk based on the analyzed result (S410). In this case, it is designed to refer to the above-described eighth database (DB) among various DBs stored in the memory.

Finally, the autonomous vehicle may comprehensively determine the degree of risk (S411), and may determine which subject will receive the control authority (S412). For example, in a situation in which the degree of risk is low, the embodiments of the present disclosure may shift the vehicle control authority to the driver. In contrast, in a situation in which the degree of risk is high, the embodiments of the present disclosure may shift the vehicle control authority to the autonomous vehicle.

In other words, the autonomous vehicle considering the external environment, etc. may determine the risk level according to the weather condition, may determine the risk level according to the road condition, and may determine the driver's proficiency level. In addition, the embodiments of the present disclosure may be designed to allocate the control authority of the autonomous vehicle to the driver or the autonomous vehicle according to the determination result of three levels.

FIGS. 3 and 4 have illustrated a solution for actively granting the control authority of the autonomous vehicle of the autonomous driving levels (for example, autonomous driving levels of 3 to 5) to the vehicle or the driver based on external information (e.g., road condition information, weather condition information, etc.) of the autonomous vehicle according to one embodiment of the present disclosure.

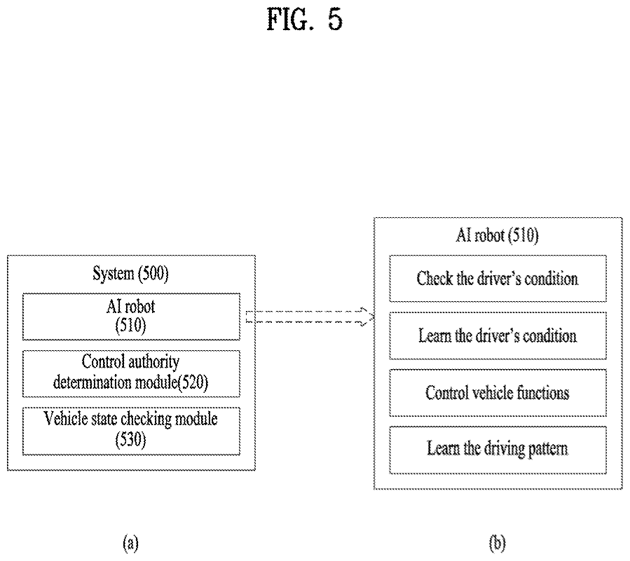

Hereinafter, a solution for granting the control authority of the autonomous vehicle having an autonomous driving level of 3 to 5 to the vehicle or the driver based on internal information (e.g., a risk level of a physical state of the driver, a risk level according to a mental or conscious state of the driver, and the like) of the autonomous vehicle will be described with reference to FIGS. 5 to 7.

However, those skilled in the art can implement another embodiment of the present disclosure by referring to FIGS. 3 to 7 without departing from the scope or spirit of the present disclosure.

FIG. 5 is a software block diagram illustrating an artificial intelligence (AI) robot embedded in the autonomous vehicle according to an embodiment of the present disclosure.

Referring to FIG. 5(a), the system 500 of the autonomous vehicle according to one embodiment of the present disclosure may include an AI robot 510, a control authority determination module 520, a vehicle state checking module 530, and the like.

The vehicle state checking module 530 may check whether the vehicle is faulty, may recognize states (e.g., battery states, oil states, brake states, etc.) for each function of the vehicle, and may determine whether autonomous driving is possible according to vehicle states.

The control authority determination module 520 may determine whether to transfer the control authority of the autonomous vehicle to the driver or to maintain the autonomous driving state of the vehicle according to the result of the driver's status report received from the AI robot 510.

As shown in FIG. 5(b), the AI robot 510 may be designed to check the driver's states, learn the driver's states, control vehicle functions, and learn driving patterns.

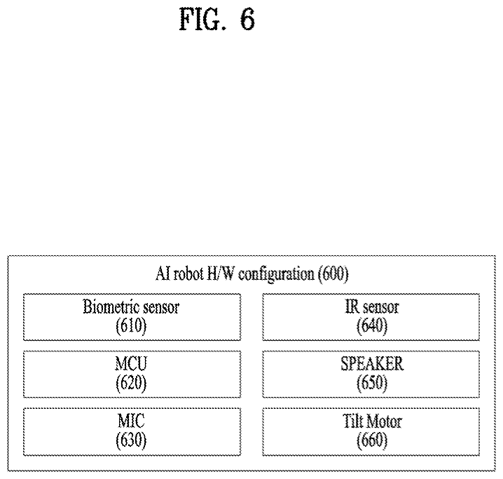

In particular, the AI robot 510 may be installed near the dashboard to monitor the driver's states, and may be designed to recognize even the mental condition of the driver by talking with the driver through a function such as an AI speaker. Hereinafter, the hardware components of the AI robot will be described in more detail with reference to FIG. 6.

FIG. 6 is a hardware block diagram illustrating the AI robot embedded in the autonomous vehicle according to an embodiment of the present disclosure.

Referring to FIG. 6, the AI robot 600 embedded in the autonomous vehicle according to an embodiment of the present disclosure may include a biometric sensor 610, a microcontroller unit (MCU) 620, a microphone 630, an infrared (IR) sensor 640, a speaker 650, a tilt motor 660, and the like.

The infrared sensor 640 may be used to easily recognize the driver's condition even at night and in dark environments.

The AI robot can converse with the driver through the microphone 630 and the speaker 650, so that the AI robot can recognize the driver's mental state and the like based on the result of conversation.

The tilt motor 660 may adjust a camera (not shown) and the infrared (IR) sensor 640, etc. in up, down, left and right directions according to the driver's position.

The biometric sensor 610 may sense the driver's physical condition. For example, the driver's physical condition can be divided into the following three levels using a heart rate monitor installed on the seat belt of the vehicle. As another example, the robot may also be designed to automatically change the determination criteria for each driver through communication with a hospital server.

The tenth database (DB) related to the driver's physical condition is shown in the following table below.

TABLE 11

| The driver's physical | |
|---|---|
| conditions | Determination Criteria |
| Level 1 | Heart rate: 80 to 100 beats per minute |
| Level 2 | Heart rate: 60 to 80 beats per minute |
| Level 3 | Heart rate: 60 (or less) beats per minute |

Through conversation with the driver using the camera (not shown), the microphone 630, the speaker 650, and the like, the MCU 620 of the AI robot may check the driver's mental and conscious conditions. For example, an arbitrary question may be output through the speaker 650 of the AI robot, so that the AI robot can classify the driver's mental and conscious conditions into the following three levels according to the driver's reaction speed.

The 11^{th} database (DB) related to the driver's mental/conscious conditions is shown in the following table.

TABLE 12

| The driver's mental/ | |
|---|---|
| conscious conditions | Determination Criteria |
| Level 1 | Case in which the driver's voice recognition is |
| | successful within 10 seconds |
| Level 2 | Case in which the driver's voice recognition is |
| | successful within 10 to 30 seconds |
| Level 3 | Case in which the driver's voice is not recognized |
| | for more than 30 seconds |

Furthermore, the AI robot may learn the driver's conditions (or states), and may establish and classify individual determination criteria for each user serving as the driver. That is, the AI robot may use different determination criteria to correctly determine the driver's conditions (or states) through such learning. The AI robot has advantages in that individual determination criteria such as excitement, distraction, and drowsiness are differently applied to the respective users, so that the driver's conditions can be more accurately sensed.

Meanwhile, the AI robot can comprehensively determine the degree of risk of the driver's condition by referring to the above-described 10^{th} and 11^{th} databases.

The 12^{th} database related to comprehensive determination of the risk of the driver's condition

TABLE 13

| Risk levels of | |
|---|---|
| Driver's condition | Determination Criteria |
| Level 1 (High) | Level 3 of the 10^{th} DB or Level 3 of the 11^{th} DB |
| Level 2 (Medium) | Level 2 of the 10^{th} DB or Level 2 of the 11^{th} DB |
| Level 3 (Low) | Level 1 of the 10^{th} DB or Level 1 of the 11^{th} DB |

In addition, the autonomous vehicle according to an embodiment of the present disclosure may determine the timing of switching a control authority of the vehicle in consideration of the sixth database related to comprehensive decision of the driver's driving proficiency and the 12^{th} database related to comprehensive decision of the driver's condition risk.

In this case, when the driver's condition corresponds to the level 1 of the 12^{th} DB or the level 1 of the sixth DB, the autonomous vehicle is designed to immediately have the control authority.

In contrast, when the driver's condition corresponds to the level 2 of the 12^{th} DB and the levels 2 and 3 of the sixth DB, the autonomous vehicle basically has the control authority, but this control authority can also be transferred upon receiving the driver's request.

In addition, even when the level 2 of the twelfth DB corresponds to 2/3 and the level 2 of the sixth DB, the autonomous vehicle basically has the control authority, but the control authority is designed to be transferred to the driver when the driver requests.

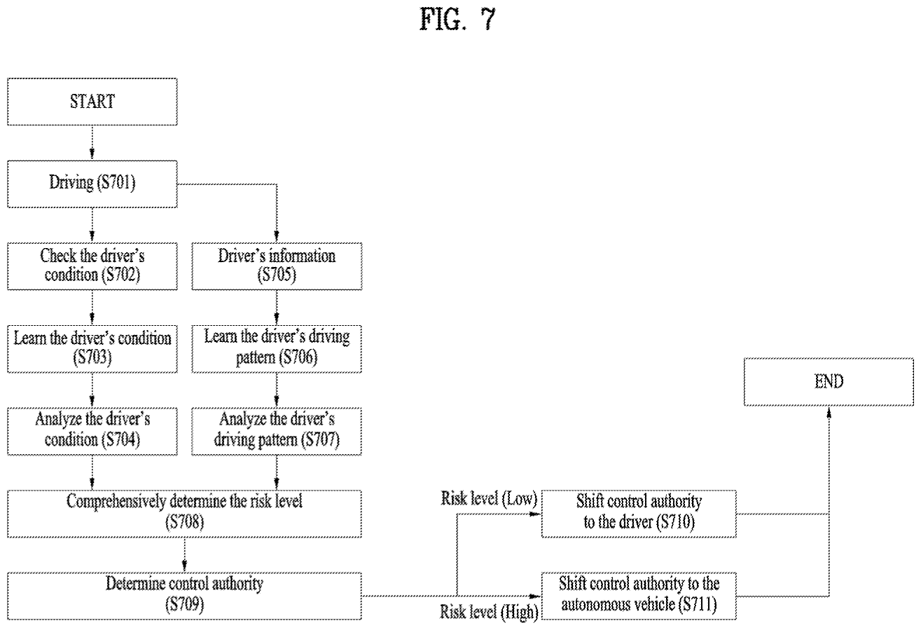

FIG. 7 is a flowchart illustrating a method of distributing vehicle control authority in consideration of the driver's conditions.

Referring to FIG. 7, the autonomous vehicle according to an embodiment of the present disclosure may start driving (S701). From this point on, the autonomous vehicle may check the driver's condition (S702), may learn the driver's condition (S703), and may analyze the driver's condition (S704). Among various DBs stored in the memory, the autonomous vehicle is designed to refer to the above-described 10^{th} and 11^{th} databases (DBs), etc.

Furthermore, the autonomous vehicle may check the driver's information (S705), may learn the driver's driving pattern (S706), and may analyze the driver's driving pattern (S707). At this time, the autonomous vehicle is designed to refer to the above-described sixth database (DB) from among various databases (DBs) stored in the memory.

Finally, the autonomous vehicle may comprehensively determine the degree of risk (S708), and may determine which subject will receive the vehicle control authority (S709). For example, in a situation where the degree of risk is low in level, the control authority is shifted to the driver (S710). In contrast, in a situation where the degree of risk is high in level, the control authority is shifted to the autonomous vehicle (S711). In this case, the autonomous vehicle is designed to refer to the 12^{th} database (DB) from among various DBs stored in the memory.

In other words, the autonomous vehicle considering the internal environment and the like may determine the risk level of the driver's physical condition, may determine the risk level of the driver's mental or conscious condition, and may determine the driver's driving proficiency level. In addition, the autonomous vehicle is designed such that the control authority thereof can be allocated to the driver or the autonomous vehicle according to the determination result of three levels.

Furthermore, according to one embodiment of determining the risk level of the driver's mental or conscious condition, the autonomous vehicle can sense the driver's consciousness condition using the camera installed therein.

Alternatively, the autonomous vehicle may analyze the driver's mental condition by having a conversation with the driver using the AI speaker (e.g., the AI robot 510 of FIG. 5) installed therein, so that the autonomous vehicle can also determine the driver's risk level based on the analyzed result.

In another aspect of the present disclosure, the above-described proposal or operation of the present disclosure may be provided as codes that may be implemented, embodied or executed by a “computer” (System on Chip (SoC)), an application storing or containing the codes, a computer-readable storage medium, a computer program product, and the like, which also comes within the scope of the present disclosure.

A detailed description of preferred embodiments of the present disclosure disclosed as described above is provided so that those skilled in the art can implement and embody the present disclosure. Although the description is made with reference to the preferred embodiments of the present disclosure, it will be appreciated by those skilled in the art that various modifications and variations can be made in the present disclosure without departing from the spirit or scope of the disclosures. For example, those skilled in the art may use the respective components described in the above-described embodiments in a manner of combining them with each other.

Accordingly, the present disclosure is not intended to be limited to the embodiments shown herein, but to be given the broadest scope that matches the principles and novel features disclosed herein.

As is apparent from the above description, the method and apparatus for controlling the autonomous vehicle according to the embodiments of the present disclosure may transfer all or some of the vehicle control authority to the driver in consideration of the driver's driving skill, road states, weather conditions, etc., thereby contributing to a smooth traffic environment and reducing the possibility of traffic accidents.

The method and apparatus for controlling the autonomous vehicle according to the embodiments of the present disclosure can actively determine the vehicle control authority to improve convenience of the driver who rides in the vehicle.

Various embodiments of the present disclosure do not list all available combinations but are for describing a representative aspect of the present disclosure, and descriptions of various embodiments may be applied independently or may be applied through a combination of two or more.

Moreover, various embodiments of the present disclosure may be implemented with hardware, firmware, software, or a combination thereof. In a case where various embodiments of the present disclosure are implemented with hardware, various embodiments of the present disclosure may be implemented with one or more application specific integrated circuits (ASICs), digital signal processors (DSPs), digital signal processing devices (DSPDs), programmable logic devices (PLDs), field programmable gate arrays (FPGAs), general processors, controllers, microcontrollers, or microprocessors.

The scope of the present disclosure may include software or machine-executable instructions (for example, an operation system (OS), applications, firmware, programs, etc.), which enable operations of a method according to various embodiments to be executed in a device or a computer, and a non-transitory computer-readable medium capable of being executed in a device or a computer each storing the software or the instructions.

A number of embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation.

Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure

1. A method for changing a control authority of an autonomous vehicle, the method comprising:
determining to allocate a control authority of the autonomous vehicle to a driver;
checking if a reaction of the driver is detected for a predetermined time; and
in response that the reaction is not detected for the predetermined time, allocating the control authority of the autonomous vehicle to the autonomous vehicle.

2. The method according to claim 1, further comprising:
determining first a risk level of a physical condition of a driver who drives an autonomous vehicle;
determining a second risk level in response to one of a mental condition or a conscious condition of the driver; and
determining a driving proficiency level of the driver,
wherein the allocating of the control authority to the autonomous vehicle is performed according to a result of a determination of the first risk level, the second risk level, and the driving proficiency level,
wherein the determining the second risk level comprises sensing the conscious condition of the driver using a camera installed in the autonomous vehicle.

3. The method according to claim 2, wherein the determining the second risk level comprises analyzing the mental condition of the driver by having a conversation with the driver through an artificial intelligence (AI) speaker installed in the autonomous vehicle.

4. The method according to claim 1, further comprising using the autonomous vehicle in any one of autonomous driving levels 3 to 5.

5. The method according to claim 1, further comprising:
determining a third risk level in response to a weather condition;
determining a fourth risk level in response to a road condition; and
determining a driver proficiency level of a driver of an autonomous vehicle,
wherein the allocating of the control authority to the autonomous vehicle is performed according to a result of a determination of the third risk level, the fourth risk level, and the driving proficiency level.

6. The method according to claim 5, wherein the determining the driver proficiency level comprises determining the driver proficiency level using at least one of an accident occurrence risk, an acceleration/deceleration pattern, and a lane change pattern.

7. The method according to claim 6, wherein the accident occurrence risk is determined using at least one of a risk of collision with a preceding vehicle, a risk of collision with a side-lane vehicle, and a risk of collision with a following vehicle.

8. (canceled)

9. An autonomous vehicle, the autonomous vehicle comprising:
at least one sensor configured to obtain driving information of the autonomous vehicle, or detect an inside or outside object of the autonomous vehicle; and
a controller, wherein the controller is configured to:
determine to allocate a control authority of the autonomous vehicle to a driver;
check if a reaction of the driver is detected for a predetermined time; and
in response that the reaction is not detected for the predetermined time, allocate the control authority of the autonomous vehicle to the autonomous vehicle.

10. The autonomous vehicle according to claim 9, wherein the controller is configured to determine a driver proficiency level using at least one of an accident occurrence risk, an acceleration/deceleration pattern, and a lane change pattern.

11. The autonomous vehicle according to claim 10, wherein the controller is configured to determine the accident occurrence risk using at least one of a risk of collision with a preceding vehicle, a risk of collision with a side-lane vehicle, and a risk of collision with a following vehicle.

12. The autonomous vehicle according to claim 9, wherein the autonomous vehicle is used in any one of autonomous driving levels 3 to 5.

13. The autonomous vehicle according to claim 9, wherein the controller is configured to:
determine first a risk level of a physical condition of a driver who drives an autonomous vehicle;
determine a second risk level in response to one of a mental condition or a conscious condition of the driver; and
determine a driving proficiency level of the driver,
wherein the allocation of the control authority to the autonomous vehicle is performed according to a result of a determination of the first risk level, the second risk level, and the driving proficiency level, and
wherein the controller is configured to sense the conscious condition of the driver using a camera installed in the autonomous vehicle for the determination of the second risk level.

14. The autonomous vehicle according to claim 13, wherein the controller is configured to analyze the mental condition of the driver by having a conversation with the driver through an artificial intelligence (AI) speaker installed in the autonomous vehicle for the determination of the second risk level.

15. The autonomous vehicle according to claim 9, wherein the controller is configured to:
determine a third risk level in response to a weather condition;
determine a fourth risk level in response to a road condition; and
determine a driver proficiency level of a driver of an autonomous vehicle,
wherein the allocation of the control authority to the autonomous vehicle is performed according to a result of a determination of the third risk level, the fourth risk level, and the driving proficiency level.

16. A non-transitory computer-readable medium having stored thereon a computer program configured to perform the method defined in one of claim 1.
